(19) United States
(12) Patent Application Publication
(10) Pub. No.: US 2009/0322957 A1
(43) Pub. Date: Dec. 31, 2009

(54) Image Processing Method and Related Apparatus for Calculating Target Motion Vector Used for Image Block to be Interpolated

(75) Inventors: Chung-Yi Chen, Hsinchu Hsien (TW); Su-Chun Wang, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MSTAR SEMICONDUCTOR, INC., Hsinchu Hsien (TW)

(21) Appl. No.: 12/491,356

(22) Filed: Jun. 25, 2009

(30) Foreign Application Priority Data
Jun. 26, 2008 (TW) 097123911

(51) Int. Cl. H04N 5/14

(52) U.S. Cl. 348/699; 348/E05.062

(57) ABSTRACT

An image processing method includes: detecting a motion vector of a source image block within a first video image to determine a flag value of the source image block, wherein the flag is used for indicating whether image content of the source image block correspondingly includes sight variations; and determining a target motion vector used for an interpolated image block according to the flag value.

### CROSS REFERENCE TO RELATED PATENT APPLICATION

This patent application is based on Taiwan, R.O.C. patent application No. 097123911 filed on Jun. 26, 2008.

### FIELD OF THE INVENTION

The present invention relates to an image processing mechanism, and more particularly, to an image processing method and a related apparatus for determining a target motion vector of an interpolated image block by way of detecting an image object tracked by a panning camera within content of a video image.

### BACKGROUND OF THE INVENTION

Generally speaking, a motion vector needed by an interpolated image block in an interpolated image is generated and determined with reference to image blocks of two images at neighboring time points. The interpolated image block is then generated at a position where the image block is supposed to be interpolated. However, a serious interpolation error occurs when a general image interpolation method is directly used for interpolating certain kinds of images. Taking a motion picture for example, a moving object therein is tracked by a panning camera. As a result, the tracked object shown in the motion picture has a slow motion corresponding to a smaller motion vector, and other background images in the motion picture have a faster motion corresponding to a greater motion vector. When the object tracked by the panning camera is constantly located near a center of the picture, the error does not occur when the conventional method mentioned above is used for determining the motion vector for image interpolation. However, when the object is suddenly covered by a background, a true motion direction of the image object is not likely to be detected. FIG. 1 shows a schematic diagram of image interpolation on a frame data using a conventional method. Diagonally-shaded areas represent a running person tracked by a panning camera, and hollow areas and grid-shaded areas respectively represent greens and trees. Referring to a left half of FIG. 1, the person is totally covered by the trees at the time point of a frame f3 but suddenly becomes partially covered at the time point of a frame f3′. For convenience of description, the panning camera moving horizontally for tracking the person is schematically illustrated in FIG. 1, in which a relationship among relative positions of the person, the greens and the trees is schematically illustrated as well. The person can be seen in a frame f2 but is totally covered by the trees in the frame f3. Referring to a right half of FIG. 1, the person can be seen in a frame f2′ but becomes partially covered by the trees in the frame f3′. Regardless of the type of circumstances mentioned above, when a conventional method is used for determining the motion vector needed by the interpolated image block, a similar image block is selected to interpolate into the image block positions P1 and P1′. However, the similar image block does not truly represent the image block corresponding to the person; in other words, the interpolation error occurs when an unrelated image block is interpolated into the image block positions P1 and P1′ where the image of the person is supposed to be interpolated when using the conventional method.

In addition, when an image object is covered by a background image in a frame but appears in the next frame of a picture, the foregoing interpolation error is likely incurred when the conventional method is used for determining a motion vector needed by an interpolated image block. For example, FIG. 2 shows image interpolation on another frame data using the conventional method. Referring to a left half of FIG. 2, a person represented by the diagonally-shaded area is partially covered by trees in a frame f4 but becomes revealed from the trees represented by grid-shaded areas in a frame f5; that is, the whole image of the person can be seen. Referring to a right half of FIG. 2, when the conventional method is used for determining the motion vector of an image fᵢₙₜₑᵣ at a position P2 where the image block is to be interpolated, the image at a position P2′ in a frame f4′ is greatly different from the image at a position P22″ in a frame f5′. Other similar but unrelated image blocks are nevertheless interpolated into the position P2 using the conventional method. Therefore, image interpolation errors still occur because the similar but unrelated image blocks do not represent the covered part of the person by the trees. Taking the right half of FIG. 2 as an example, an obvious error occurs when an image representing a green at a position P2″ is directly interpolated into the position P2.

### SUMMARY OF THE INVENTION

One of the objectives of the invention is to provide an image processing method and a related apparatus for calculating a target motion vector of an interpolated image block by detecting whether an image object tracked by a panning camera is present within a motion picture, so as to solve the problem mentioned above.

An image processing method is disclosed according to an embodiment of the present invention. The image processing method comprises steps of detecting a motion vector of a source image block within a first video image for determining a flag value of the source image block, wherein the flag value is used to indicate whether the source image block has a relatively-smaller variation; and calculating a target motion vector used for an interpolated image block according to the flag value.

An image processing apparatus is provided according to another embodiment of the present invention. The image processing apparatus at least comprises a processing circuit and a computing circuit. The processing circuit is for detecting a motion vector of a source image block within a first video image for determining a flag value of the source image block, wherein the flag value is used to indicate whether the source image block has a relatively-smaller variation. The computing circuit coupled to the processing circuit calculates a target motion vector of an interpolated image block according to the flag value.

### BRIEF DESCRIPTION OF THE DRAWINGS

FIG. 1 is a schematic diagram of image interpolation on a frame data using a conventional method.

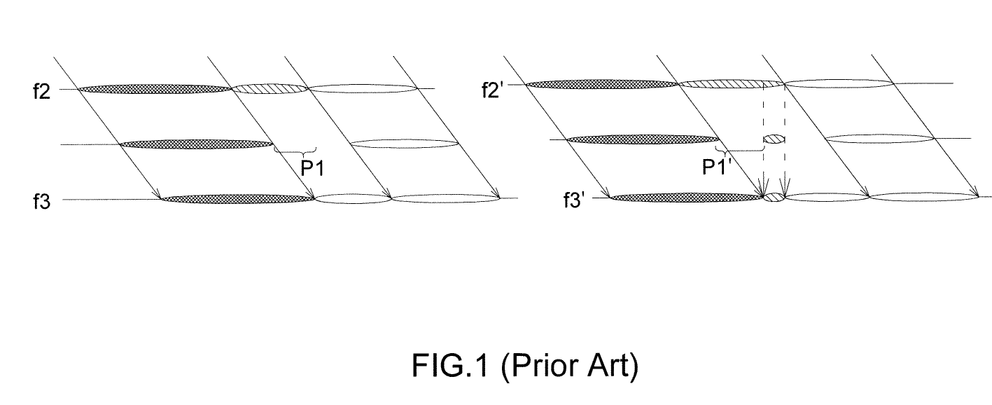

FIG. 2 is a schematic diagram of image interpolation on another frame data using a conventional method.

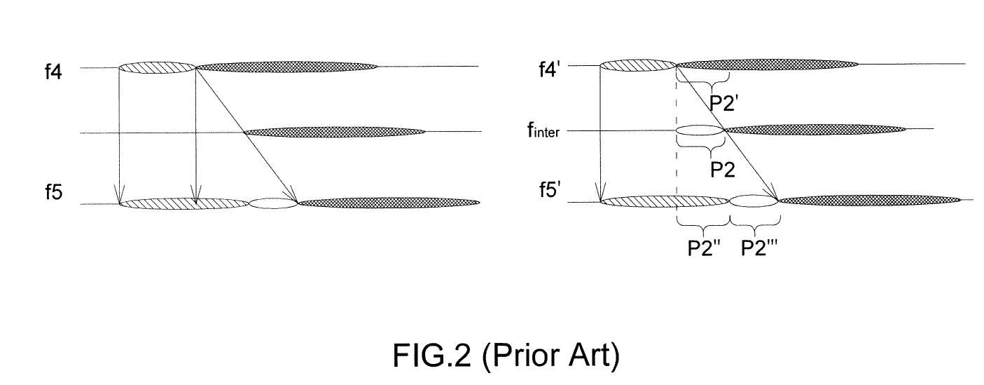

FIG. 3 is a schematic diagram of an image processing apparatus in accordance with an embodiment of the present invention.

FIG. 4 is a schematic diagram of an example of image interpolation on frame data by implementing the image processing apparatus shown in FIG. 3.

FIG. 5A is an operation flow chart of the image processing apparatus shown in FIG. 3.

FIG. 5B is a continuing flow chart of FIG. 5A.

### DETAILED DESCRIPTION OF THE PREFERRED EMBODIMENT

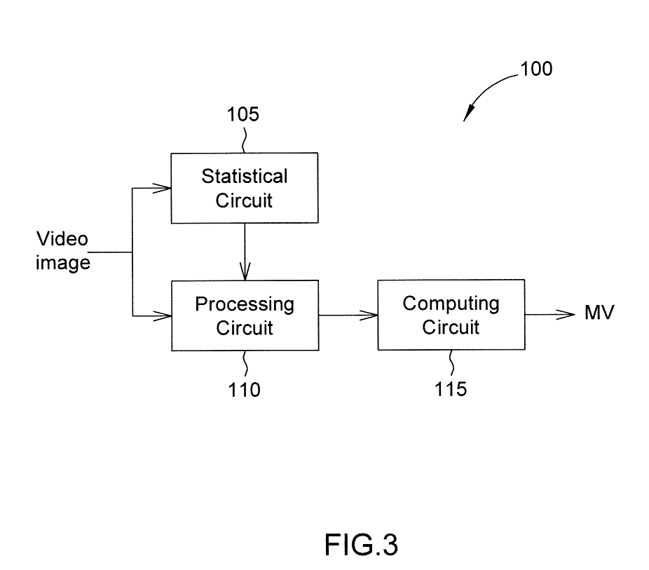

FIG. 3 shows a schematic diagram of an image processing apparatus 100 in accordance with one preferred embodiment of the present invention. The image processing apparatus 100 comprises a statistical circuit 105, a processing circuit 110 and a computing circuit 115. The processing circuit 110 is used to determine a flag value V_{flag} of a source image block by at least detecting a motion vector MV′ of the source image block within a first video image. The flag value V_{flag} is used for indicating whether image content of the corresponding image block includes slight variations, so as to indicate whether the source image block corresponds to an image object tracked by a panning camera. It is noted that, an objective of the image processing apparatus 100 is employed to determine a target motion vector MV required for interpolating an image block MB of an image to be interpolated. The first video image is any reference video image prior to the image to be interpolated, and the flag value V_{flag} is used as a reference when the computing circuit 115 determines the target motion vector MV.

In practice, the statistical circuit 105, coupled to the processing circuit 110, determines the number of the image blocks having a motion vector greater than a predetermined vector Vₚᵣₑ within the first video image. The processing circuit 110 is thereafter allowed to check whether the number of the image blocks is greater than or equal to a specific value N₁, so as to determine whether a circumstance of a background image moving quickly takes place within the first video image. In other words, the processing circuit 110 checks whether the number of the motion vectors greater than the predetermined vector Vₚᵣₑ is above a predetermined ratio of the total number of motion vectors within the first video image. The value N₁ can be set in advance or dynamically adjusted. Note that when the image object is tracked by a panning camera, the rest of the background occupies a great ratio of the first video image. As a result, when the number of the motion vectors greater than the predetermined motion vector Vₚᵣₑ is greater than or equal to the predetermined value N₁, the processing circuit 110 determines that the circumstance of the background image moving quickly takes place within the first video image and then executes an operation of setting the flag value; otherwise, the circumstance of the background moving quickly does not take place within the first video image. Regardless of whether any image block within the first video image comprises the motion vector greater than the predetermined vector Vₚᵣₑ, the processing circuit 110 would set the flag value of all the image blocks within the first video image in advance to indicate that respective image blocks do not correspond to the image object tracked by the panning camera. In order to ensure whether the circumstance of the image background moving quickly takes place, the processing circuit 110 further checks whether the motion vectors greater than the predetermined vector Vₚᵣₑ are in a same direction; for example, whether the differences among the motion vectors are within a predetermined range. When the motion vectors greater than the predetermined vector Vₚᵣₑ are in the same direction, the processing circuit 110 then determines the circumstance of the background image moving quickly takes place within the first video image. The operation that the processing circuit 110 determines the flag value will be described in detail in the following.

In view of the foregoing issues, when the circumstance of the background image moving quickly takes place within the first video image, i.e., when the number of the motion vectors greater than the predetermined vector Vₚᵣₑ is greater than or is equal to the predetermined value N₁ and the motion vectors greater than the predetermined vector Vₚᵣₑ are in the same direction, the processing circuit 110 selects the image blocks having motion vectors smaller than the predetermined vector Vₚᵣₑ. The existence of such image blocks is indicative of the first video image is likely to have the image object tracked by the panning camera. As a result, the processing circuit 110 then sets the flag value corresponding to the image blocks as “1” to indicate that the image blocks are corresponding to the image object tracked by the panning camera, and records motion vectors of the image blocks for use of the subsequent computing circuit 115. As an example, with respect to the first video image, the processing circuit 110 determines the flag value V_{flag} by comparing the motion vector MV′ of the source image block with the predetermined vector Vₚᵣₑ. When the motion vector MV′ is smaller than the predetermined vector Vₚᵣₑ, the flag value V_{flag} of the source image block is set as “1”.

The flag value has an influence on an operation of the subsequent computing circuit 115, and hence other principles are referenced to accurately determine the flag value when determining the flag value in practice. For example, when the motion vector MV′ of the source image block is smaller than the predetermined vector Vₚᵣₑ, the processing circuit 110 determines the flag value V_{flag} of the source image block by determining whether a motion vector of at least one image block adjacent to the source image block is smaller than the predetermined vector Vₚᵣₑ. The reason is that the object tracked by the panning camera is generally larger than a single image block. Therefore, when the motion vector MV′ of the source image block is smaller than the predetermined vector Vₚᵣₑ, and the motion vector of the at least one image block adjacent to the source image block is smaller than the predetermined vector Vₚᵣₑ, it is then reasonable to state that the source image block is corresponding to the image object tracked by the panning camera. Hence, when the motion vector MV′ of the source image block is smaller than the predetermined vector Vₚᵣₑ but abnormally no motion vector among motion vectors of the adjacent image block is smaller than the predetermined vector Vₚᵣₑ, it likely that the motion vector MV′ of the source image block is erroneously found to be smaller than the predetermined vector Vₚᵣₑ because of a calculation error. The processing circuit 110 then sets the flag value V_{flag} of the source image block as “0” to represent that the source image block does not correspond to the image object tracked by the panning camera.

In view of the foregoing issues, in order to confirm the flag value V_{flag}, the processing circuit 110 calculates a block difference D₁ between the source image block and another image block MB₁. The motion vector of the image block MB₁ is smaller than the predetermined vector Vₚᵣₑ; that is, MB₁ corresponds to the image object tracked by the panning camera. The processing circuit 110 also calculates a block difference D₂ between the source image block and an image block MB₂. The motion vector of the image block MB₂ is greater than the predetermined vector Vₚᵣₑ; that is, MB₂ corresponds to the background image. The processing circuit 110 then determines the flag value V_{flag} of the source image block by determining whether the block difference D₁ is far smaller than the block difference D₂. Taking the previous example of the person and trees, the block difference D₁ between two image blocks corresponding to the person is far smaller than the block difference D₂ between two image blocks respectively corresponding to the person and trees. Thus, when the block difference D₁ is far smaller than the block difference D₂, the processing circuit 110 further sets the flag value V_{flag} of the source image block as “1”; otherwise, the processing circuit 110 sets the flag value V_{flag} as “0”.

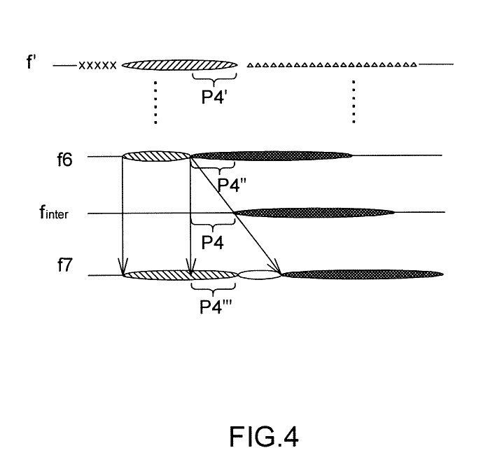

After the flag value V_{flag} is determined as discussed above, the computing circuit 115 coupled to the processing circuit 110 calculates the target motion vector MV of the image block MB to be interpolated according to the flag value V_{flag}. In this embodiment, in the image to be interpolated, a position of the image block MB to be interpolated is a corresponding position of the source image block in the first video image. However, it shall not be construed in limiting sense. Particularly, the computing circuit 115 determines whether the motion vector MV′ of the source image block recorded by the processing circuit 110 is set to be a candidate motion vector of the image block MB to be interpolated. The computing circuit 115 then selects the target motion vector MV of the image block MB to be interpolated from all candidate motion vectors. It is noted that, an ideal value of the motion vector of the source image block corresponding to the image object tracked by the panning camera is zero. Hence in a following step of determining the target motion vector MV, the motion vector of zero is also taken into consideration. FIG. 4 shows a schematic diagram of an example of image interpolation on frame data by implementing the image processing apparatus 100 shown in FIG. 3. Diagonally-shaded areas represent an object tracked by a panning camera, such as a running person. Hollow areas, grid-shaded areas, cross signs and triangle signs respectively represent different background images, such as greens, trees and so on. When the first video image mentioned above refers to f′, and the image block MB to be interpolated and the source image block are respectively at positions of P4 and P4′, the processing circuit 110 shall set the flag value V_{flag} as “1” and record the motion vector MV′ of the source image block, with the motion vector MV′ being a theoretical value of zero. When the motion vector MV′ is zero, the image needed by the interpolated image block is generated referring to an image block at a same position within an adjacent video image.

The flag value V_{flag} of the source image block indicates whether the source image block is corresponding to the image object tracked by the panning camera. Thus, the computing circuit 115 sets the motion vector MV′ of the source image block as a candidate motion vector probably used when generating the image block MB to be interpolated. Specifically, when the target motion vector MV of the image block MB to be interpolated is determined, the computing circuit 115 calculates candidate block differences D₁′, D₂′, . . . and Dₙ′ respectively corresponding to each candidate motion vector, supposing there are n candidate motion vectors. For example, when the motion vector MV′ is zero, the candidate block difference D₁′ is a difference between an image at a position P4″ of a frame f6 and an image at a position P4′″ of a frame f7. However, the computing circuit 115 appropriately adjusts candidate block differences D₁′, D₂′, . . . and Dₙ′ such that the candidate block difference D₁′ is smaller than the candidate block differences D₂′, . . . and Dₙ′ according to the motion vector MV′, such as the computing circuit 115 reducing the candidate block difference D₁′ by dividing D₁′ by 2 or increasing the candidate block differences D₂′, . . . and Dₙ′. Consequently, a chance of selecting D₁′ is increased when the computing circuit 115 selects the smallest block difference from candidate block differences D₁′, D₂′, . . . and Dₙ′ of the image block MB to be interpolated. As a result, the motion vector MV′ corresponding to D₁′ is used as the target motion MV of the interpolated image block by the computing circuit 115.

In terms of image quality, when the image object tracked by the panning camera suddenly shows up in the frame f7, in order not to generate an artificial-looking image of the image block MB to be interpolated at the position P4, it is better to generate the image block MB to be interpolated by use of the image at the position P4″ of the frame f6 or the image at the position P4′″ of the frame f7. Preferably, the motion vector MV′ with a value of zero is set as the target motion vector MV of the image block MB to be interpolated by the computing circuit 115. On the contrary, when the flag value V_{flag} of the source image block indicates the source image block does not correspond to any image object tracked by the panning camera, that is, the flag value V_{flag} is set as “0”, the computing circuit 115 shall not intentionally set the motion vector MV′ of the source image block as the candidate motion vector when the image block MB to be interpolated is generated. No interpolation error occurs then. For example, when the source image block at the position P4′ within the first video image of FIG. 4 corresponds to trees represented by grid-shaded areas instead of the person represented by diagonally-shaded areas, the flag value of the source image block shall be “0”. Hence, the computing circuit 115 generates the motion vector of the image block MB to be interpolated at the position P4 within the interpolation image fᵢₙₜₑᵣ by performing conventional block matching and searching, but does not intentionally set other motion vectors related to the flag value as the candidate motion vector.

In addition, the processing circuit 110 may need to clear content of the flag value V_{flag} previously set as 1 to null. Referring to FIG. 4, a scene change is detected within either of the first video image f′ and the video image f6; that is, the video images f6/f7 are detected to be scene pictures different from the first video image f′ video image. When the target motion vector MV of the image block MB to be interpolated is determined by the computing circuit 115, in order to avoid intentionally setting the motion vector MV′ of the source image block with a high possibility of being selected as the target motion vector MV, the processing circuit 110 clears the flag value V_{flag} previously set as “1” of the source image block. The flag value V_{flag} then indicates image content of the source image block does not correspondingly comprise slight variations. As a result, even if the scene is changed, an error does not occur for the reason that the motion vector MV′ has the high possibility of being selected as the target motion vector MV of the image block MB to be interpolated.

In addition, when the image object is determined as being tracked by the panning camera in the first image figure f′, the processing circuit 110 constantly checks whether a same circumstance takes place in subsequent video images. If the answer is no, the processing circuit 110 clears the flag value set as “1” within the first video image f′, such as V_{flag} as shown in FIG. 4. For example, within a video image between the first video image f′ and the video image f6, when it is detected/determined that the number of image blocks having the motion vector greater than the predetermined vector Vₚᵣₑ is less than the specific value N₁, it means that no specific image is tracked by the panning camera within the video image. More specifically, image content of the source image block does not correspondingly comprise slight variations. At this point, the processing circuit 110 clears content of the flag value V_{flag} of the source image block, so that the computing circuit 115 shall not intentionally set the motion vector MV′ of the source image block with the high possibility of being selected as the target motion vector MV.

Moreover, in this embodiment, when the flag value V_{flag} of the source image block within the first video image f′ is determined as “1”, the processing circuit 110 constantly checks whether a flag value of at least one adjacent image block, within the adjacent image block having a same position as the image block of the source image block among subsequent image blocks, is set as “1”. When no adjacent image block within the adjacent image block is set as “1”, the processing circuit 110 then clears the flag value V_{flag} of the source image block within the first video image f′, so as to avoid intentionally setting the motion vector MV′ of the source image block with the high possibility of being selected as the target motion vector MV of the image block MB to be interpolated.

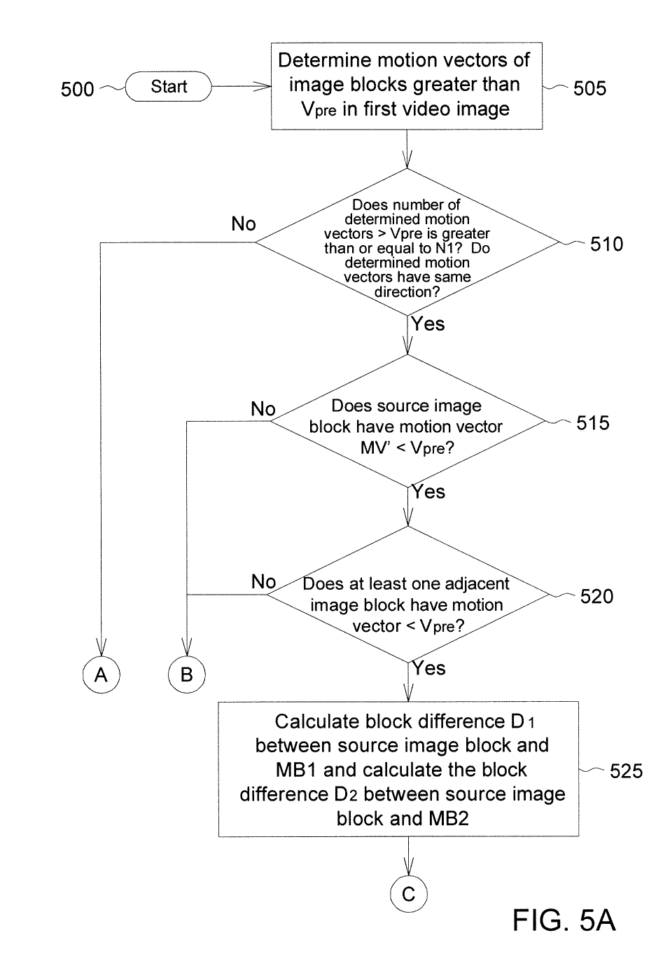

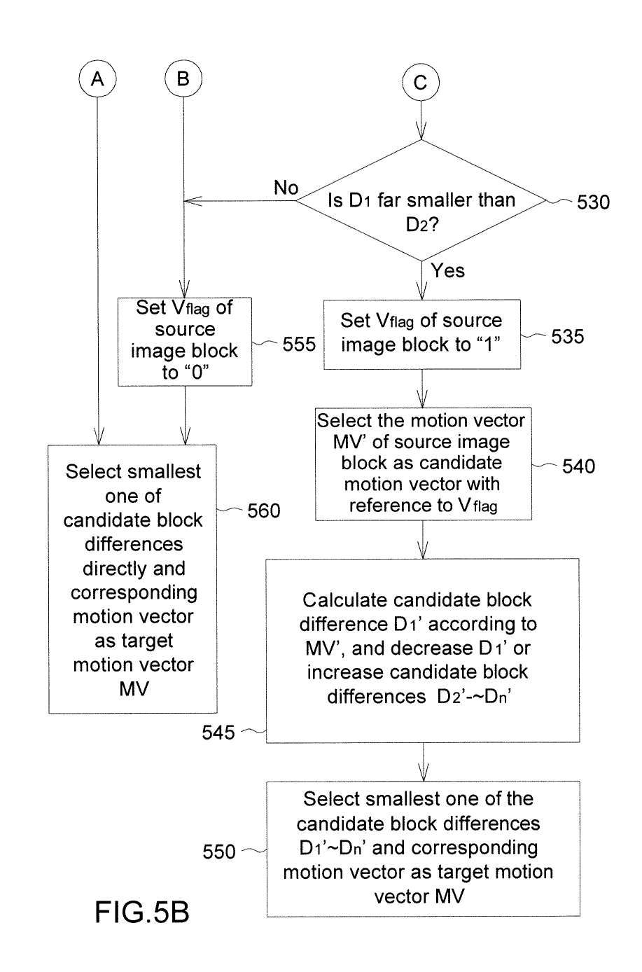

It is noted that, FIG. 4 is a schematic diagram of an example of an operation method of the image processing apparatus 100 when the image object tracked by the panning camera suddenly appears. However, the image processing apparatus 100 is also used for determining a preferred target motion vector to avoid an artificially-looking image when the image object tracked by the panning camera suddenly disappears. The details shall not be discussed for brevity. An operation flow chart of the image processing apparatus shown in FIG. 3 is as illustrated in FIG. 5A and FIG. 5B for readers to quickly understand the spirit of the present invention. Steps of the operation flow chart, namely steps 500-560, are not unnecessarily further described.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An image processing method, comprising steps of:
providing a first video image having a source image block;
detecting a motion vector of the source image block to determine a flag value of the source image block, wherein the flag value indicates whether the source image block has a relatively-smaller variation; and
determining a target motion vector for interpolating a target image block according to the flag value.

2. The image processing method as claimed in claim 1, wherein the interpolated image block is located at a corresponding position as the source image block.

3. The image processing method as claimed in claim 1, wherein the step of determining comprises steps of:
(a) optionally setting the motion vector of the source image block as a candidate motion vector of the interpolated image block according to the flag value; and
(b) selecting the target motion vector from a plurality of candidate motion vectors of the interpolated image block.

4. The image processing method as claimed in claim 3, wherein the step (a) comprises:
setting the motion vector of the source image block as the candidate motion vector when the flag value indicates the source image block has the relatively-smaller variation.

5. The image processing method as claimed in claim 4, wherein the step (a) further comprises:
when the flag value indicates the source image block has the relatively-smaller variation, determining a candidate block difference used for the interpolated image block by using the motion vector of the source image block, decreasing the candidate block difference relative to others; and the step (b) further comprises:
selecting a smallest block difference among the candidate block differences of the interpolated image block, and setting a motion vector corresponding to the smallest block difference as the target motion vector.

6. The image processing method as claimed in claim 1, further comprising steps of:
within the first video image, determining the number of image blocks having motion vectors greater than a predetermined vector, and determining whether the number of the image blocks having the motion vectors greater than the predetermined vector is greater than a specific value; and
the step of determining the flag value of the source image block, comprising:
when the number of the image blocks having the motion vectors greater than the predetermined vector is greater than the specific value and differences among a plurality of motion vectors are in a predetermined range, comparing the motion vector of the source image block with the predetermined vector to determine the flag value of the source image block.

7. The image processing method as claimed in claim 6, wherein the step of comparing the motion vector of the source image block with the predetermined vector to determine the flag value of the source image block, comprises:
when the motion vector of the source image block is smaller than the predetermined vector, determining whether a motion vector of a least one image block adjacent to the source image block is smaller than the predetermined vector to determine the flag value of the source image block.

8. The image processing method as claimed in claim 6, wherein the step of comparing the motion vector of the source image block with the predetermined vector to determine the flag value of the source image block, further comprises:
when the motion vector of the source image block is smaller than the predetermined vector, determining a first block difference between the source image block and an image block having a motion vector smaller than the predetermined vector;
determining a second block difference between the source image block and an image block having a motion vector greater than the predetermined vector; and
determining the flag value of the source image block by determining whether the first block difference is smaller than the second block difference.

9. The image processing method as claimed in claim 1, further comprising:
within a second video image subsequent to the first video image, determining the number of image blocks having a motion vector greater than a predetermined vector, and determining whether the number of the image blocks having the motion vectors greater than the predetermined vector is smaller than a specific value; and
determining the flag value of the source image block to indicate the source image block having the relatively smaller variation when the number of the image blocks having a motion vector greater than the predetermined vector is smaller than the specific value.

10. The image processing method as claimed in claim 1, further comprising:
determining the flag value of the source image block to indicate the source image block having the relatively-smaller variation when a scene change is detected after the first video image.

11. An image processing apparatus, comprising:
a processing circuit, for detecting a motion vector of a source image block within a first video image to determine a flag value of the source image block, wherein the flag value indicates whether the source image block has a relatively-smaller variation; and
a computing circuit, coupled to the processing circuit, for determining a target motion vector of an interpolated image block according to the flag value.

12. The image processing apparatus as claimed in claim 11, wherein the interpolated image block is located at a corresponding position as the source image block.

13. The image processing apparatus as claimed in claim 11, wherein the computing circuit optionally sets the motion vector of the source image block as a candidate motion vector of the interpolated image block according the flag value, and selecting the target motion vector from a plurality of candidate motion vectors of the interpolated image block.

14. The image processing apparatus as claimed in claim 13, wherein the flag value indicates the source image block having the relatively-smaller variation, and the computing circuit sets the motion vector of the source image block as the candidate motion vector.

15. The image processing apparatus as claimed in claim 14, wherein when the flag value indicates whether the source image block has the relatively-smaller variation, the computing circuit calculates a candidate block difference of the interpolated image block by using the motion vector of the source image block, decreases the candidate block difference relative to others; and the computing circuit selects a smallest block difference from the plurality of candidate block differences of the interpolated image block, and sets a motion vector corresponding to the smallest block difference as the target motion vector.

16. The image processing apparatus as claimed in claim 11, further comprising:
a statistical circuit, coupled to the processing circuit, for determining the number of image blocks having a motion vector greater than a predetermined vector;
wherein, the processing circuit further determines whether the number of image blocks having a motion vector greater than the predetermined vector is greater than a specific value; and when the number of the image blocks having a motion vector greater than the predetermined vector is greater than the specific value and differences among the plurality of motion vectors are in a predetermined range, the processing circuit determines the flag value of the source image block by comparing the motion vector of the first image with the predetermined vector.

17. The processing apparatus as claimed in claim 16, wherein when the motion vector of the source image block is smaller than the predetermined vector, the processing circuit determines the flag value of the source image block by determining whether a motion vector of at least one image block adjacent to the source image block is smaller than the predetermined vector.

18. The processing apparatus as claimed in claim 16, wherein when the motion vector of the source image block is smaller than the predetermined vector, the processing circuit calculates a first block difference between the source image block and an image block having a motion vector smaller than the predetermined vector and a second block difference between the source image block and an image block having a motion vector greater than the predetermined vector, and determines the flag value of the source image block by determining whether the first block difference is smaller than the second block difference.

19. The image processing apparatus as claimed in claim 11, further comprising:
a statistical circuit, coupled to the processing circuit, for determining the number of image blocks having a motion vector greater than a predetermined vector within a second video image subsequent to the first video image;
wherein, the processing circuit determines whether the number of image blocks having the motion vectors greater than the predetermined vector is smaller than a specific value; and when the number of image blocks having the motion vectors greater than the predetermined vector is smaller than a specific value, the processing circuit determines the flag value of the source image block to indicate the source image block does not have the relatively-smaller variation.

20. The image processing apparatus as claimed in claim 11, wherein when a scene change is detected after the first video image, the processing circuit determines the flag value of the source image block to indicate image content does not have the relatively-smaller variation.
